(19) United States
(12) Patent Application Publication
(10) Pub. No.: US 2004/0194596 A1
(43) Pub. Date: Oct. 7, 2004

(54) Blade slit covering on a cutting and feed roller

(76) Inventor: Fritz Achelpohl, Lienen (DE)

Correspondence Address: JACOBSON HOLMAN PLLC, 400 SEVENTH STREET N.W., SUITE 600, WASHINGTON, DC, 20004, US

(21) Appl. No.: 10/491,341

(22) PCT Filed: Dec. 19, 2001
(86) PCT No.: PCT/EP01/15090

(51) Int. Cl. B26D 1/56

(52) U.S. Cl. 83/304; 83/331

(57) ABSTRACT

The invention relates to a method for cutting webs of material (12), which rest upon the peripheral surface of the cutting and feed roller (1) and to a cutting and feed roller (1). These webs of material are cut through by means of a cutting device that, when in its position of rest, is essentially located inside the lateral surface (2) of the cutting and feed roller (1). This cutting device comprises at least one blade (4) that, when cutting the web of material (12), passes through an opening (3) located inside the lateral surface (2) of the cutting and feed roller (1). The opening located inside the lateral surface (2) of the cutting and feed roller (1), through which the at least one blade (4) passes during the cutting process, is closed when a cutting process is not occurring.

The invention relates to a blade slit covering on a cutting and feed roller of a winder according to the generic term of claim 1.

Cutting and feed rollers of the previously mentioned type are already known. EP 0 698 571 illustrates such a cutting and feed roller. A blade, which is initially located within the lateral surface, is characteristic for rollers of this type.

During the cutting process, the blade passes through a usually slit-shaped opening located inside the lateral surface of the cutting and feed roller, thus, in this manner, cutting the webs of material that rest upon the lateral surface of the feed roller.

The said webs of material can be damaged, however, if they contact the slit-shaped opening.

It is therefore the task of the invention to reduce or completely avoid the occurring damage.

The task is therefore solved in that the slit-shaped opening of the lateral surface of the feed roller is closed, when the blade is located in its position of rest inside of the roller.

It is particularly advantageous if the closure of the blade in its position of rest forms a part of the peripheral surface of the feed roller.

In this regard, it must be reiterated that the closure of the slit-shaped opening, which is hereinafter also referred to as a blade passage slit, may be performed by all kinds of mechanical devices suitable for this purpose. The description and patent claims list hoses, dampers, and sliders as examples.

It is also advantageous to equip a cutting and feed roller according to the invention with suction or vacuum devices, such as the ones shown in the previously mentioned application.

Additional details and advantageous embodiments of the invention can be found in the following graphic description, and in the sub-claims.

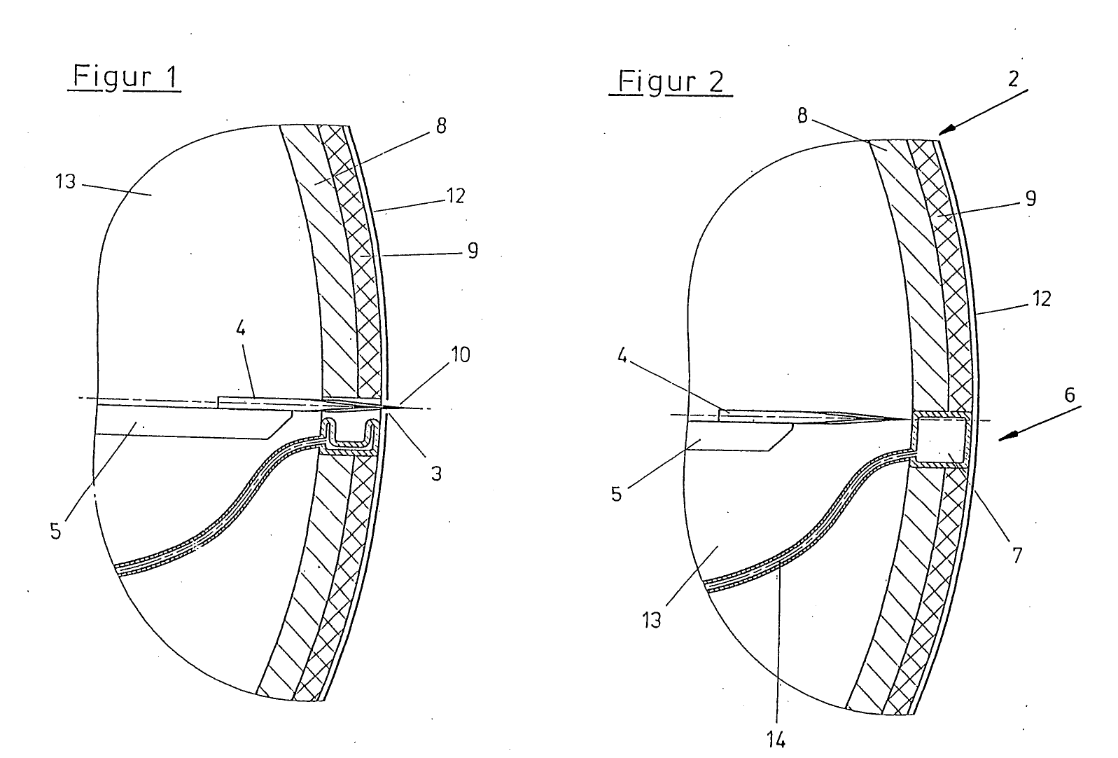

FIG. 1: FIG. 1 shows a section through the area of a web guide roller according to the invention, in which the cutting process is occurring. In this embodiment example, the blade passage slit can be closed with the aid of a hose. However, in FIG. 1, the web is cut straight.

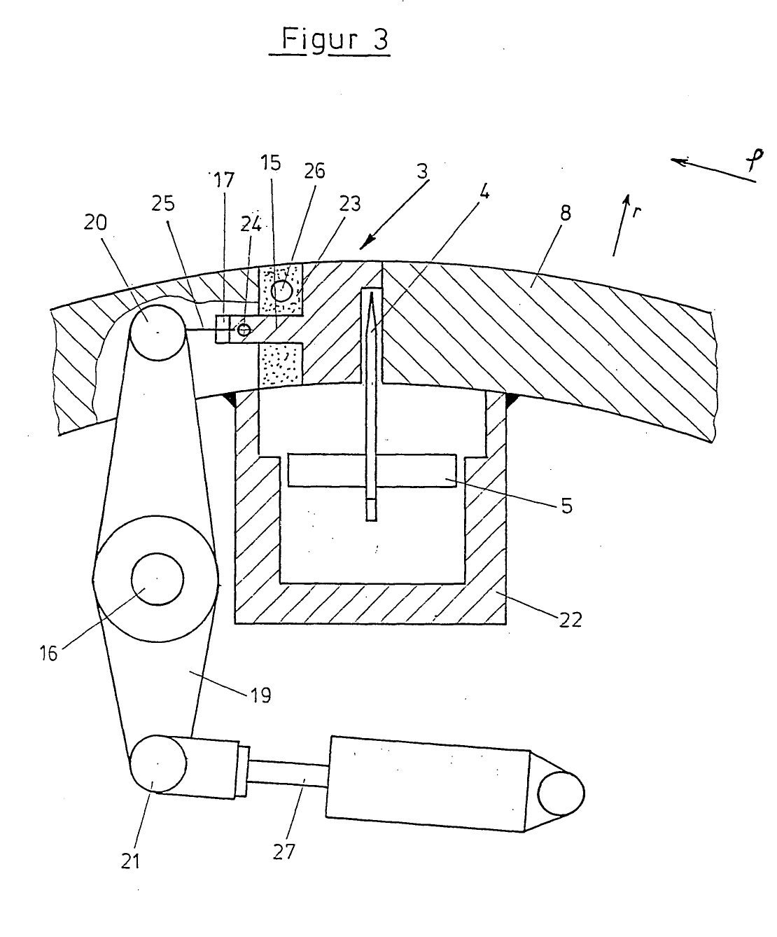

FIG. 2 FIG. 2 shows a section through the same area of the same embodiment example, whereby the blade is located inside of the web guide roller.

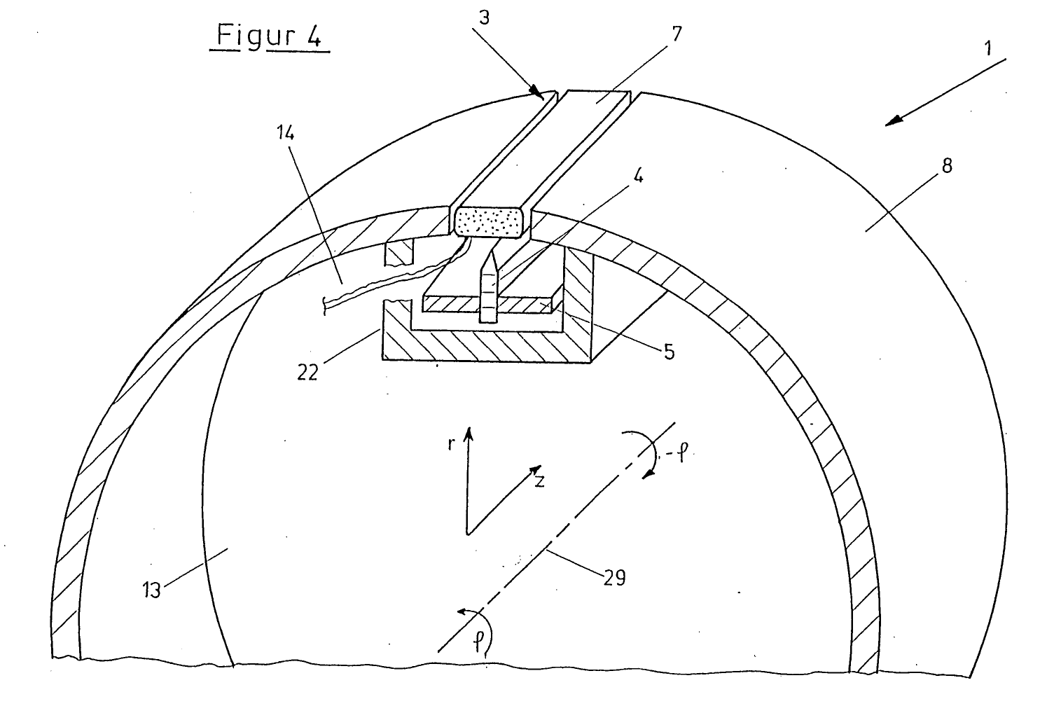

FIG. 3 In the embodiment example illustrated in FIG. 3, the blade passage slit is closed by means of a slider.

FIG. 4 FIG. 4 outlines a section through a roller according to the invention.

FIG. 1 shows a section through the area of a web guide roller 1 according to the invention in which the cutting process is occurring. In order to make it possible for the blade 4, which is carried and moved by a blade carrier 5, to pass through the outer surface 2, the outer surface comprises a blade passage slit 3. In the embodiment example shown, the outer surface 3 is made of a steel construction 8 and comprises a rubber facing 9. The cutting edge 10 of the blade 4 protrudes in radial direction beyond the peripheral surface 11 of the web guide roller, and cuts through the

sheet 12. In the embodiment example shown, the web guide roller comprises frontal coverings, one of which can be seen in the figure.

An inflatable hose 6, which is not inflated in FIG. 1, and which enables the blade 4 to pass through the blade slit is located inside of the blade slit.

If necessary, several hoses, which operate successively in, for example, axial direction (z) of the roller may be installed in the blade passage slit 3.

FIG. 3 again schematically shows a device according to the invention, in which a slider 15 closes the slit-shaped opening 3 in the roller surface. The slider 15 possesses a projection 24, which is able to glide with little clearance in the feed notch 17, which is located in the surface of the roller. In this manner, the slider is retained and guided. The projection 24 is articulated on the pull and push rod 25. The pull/push rod on its part is connected to the lever 19 with its articulation 20. The lever 19 is attached to the center of rotation 16. Furthermore, the lever is connected to the piston 27 of the pneumatic cylinder 28 by means of the articulation 21.

In the device according to the description, the pneumatic cylinder 28 transfers a force to the slider 15 by means of its piston, 27, the lever 19, and the pull/push rod 25, and opens and closes the blade slit 3 in this manner.

In order not to allow an opening relative to the surface 8 despite of the translation of the slider 15, a buffer made of flexible material 23, such as rubber, is provided between the slider and the lateral surface in the embodiment example shown. If necessary, such a buffer may contain hollow spaces, or recesses 26, respectively, in order not to protrude beyond its bulge past the steel construction of the roller in radial direction.

The entire cutting or blade guide mechanism of the cutting and feed roller is not the subject of the invention at hand, and is therefore only schematically outlined at this point. Therefore, only the box of the cutting device 22, which is attached to the steel construction 8 of the roller, as well as the blade 4 and the blade carrier 5, are illustrated. Any devices providing the force or the torque necessary during the cutting process, and which ensure that at least one blade protrudes through the blade slit 3 in radial direction beyond the steel construction 8 during the cutting process, are not illustrated in FIG. 3.

FIG. 4 serves for the total overview of a cutting and feed roller 1 according to the invention, which is not illustrated herein. Again, as with FIG. 3 the actual cutting mechanism is merely schematically outlined by means of the box of the cutting device 22, the blade 4, and the blade carrier 5.

In the embodiment example illustrated in the figure, the blade slit 3 is again closed by means of a hose 7. The hose 7 can be inflated or deflated by means of the flexible feed line 14. Any devices supplying the air pressure necessary for this, or which lead into the interior of the roller, are also known, and are therefore not shown at this point.

Also shown in the background is the frontal covering 13 of the roller, which usually limits the roller interior in the case of feed rollers according to prior art.

The roller can rotate around the roller axis 29 in both directions, which is indicated by the bent arrows f and −f, which also state the direction of the angle coordinate to be used with the description. The angle coordinates f, together with the radial r and axial z coordinates also shown by means of the coordinate cross, a cylinder coordinate system, which has already been used in the application at hand for purposes of description.

For illustration purposes, drawing 4 omits the illustration of a film to be cut.

Reference Chart

| | |
|---|---|
| Web guide roller | 1 |
| Outer surface | 2 |
| Blade passage slit | 3 |
| Blade | 4 |
| Blade carrier | 5 |
| Closure | 6 |
| Hose | 7 |
| Lateral surface of roller | 8 |
| Rubber facing of roller | 9 |
| Cutting edge of blade | 10 |
| | 11 |
| Web of material | 12 |
| Frontal covering | 13 |
| Flexible feed line | 14 |
| Slider | 15 |
| Center of rotation of lever | 16 |
| Feed notch | 17 |
| Pneumatic cylinder | 18 |
| Lever | 19 |
| Articulation of pull/push rod | 20 |
| Articulation of the lever on the piston | 21 |
| Box of cutting device | 22 |
| Buffer made of flexible material | 23 |
| Projection of slider | 24 |
| Pull/push rod | 25 |
| Recess in flexible material | 26 |
| Piston | 27 |
| Pneumatic cylinder | 28 |
| Pivot axis of roller | 29 |
| Radial coordinates | (r) |
| Axial coordinates | (z) |
| Angle coordinates | (f) |
| Bent arrow in negative pivoting direction | (−f) |

1. Cutting and feed roller (1), which comprises an outer lateral surface (2) equipped with a slit-shaped opening (3), and contains a cutting device for webs of material, which cuts through the webs of material (12) that rest upon the lateral surface (2) of the feed roller (1), whereby the cutting device comprises at least one blade (4) that is guided by a blade carrier (5), which on its part possesses at least one cutting edge (10), whereby at least one blade (4) is attached to a blade carrier (5) and protrudes through the opening in the lateral surface (3), characterized in that the blade passage slit (3) can be closed.

2. Method for cutting of webs of material (12), which are located on the peripheral surface of the cutting and feed roller (1), with the aid of a cutting device, which is essentially located inside the lateral surface (2) of the cutting and feed roller (1) in its position of rest, and which comprises at least one blade (4) that protrudes through an opening (3) in the lateral surface (2) of the cutting and feed roller (1) during the cutting process of the web of material (12), characterized in the opening in the lateral surface (2) of the cutting and feed roller (1), through which at least one blade (4) passes during the cutting process, is closed if no cutting process occurs.

3. Device and method according to claim 1, characterized in that the closure (6) of the blade passage slit (3) in the closed position forms a part of the peripheral surface of the cutting and feed roller.

4. Cutting and feed roller (1) according to claim 1, characterized in that the blade passage slit (3) can be closed with at least one roller (1) in the area of the blade passage slit (3).

5. Cutting and feed roller (1) according to claim 1, characterized in that the hose (7) is connected to a central air supply by means of at least one flexible line (14) that is embodied as a pressure feed.

6. Cutting and feed roller (1) according to claim 1, characterized in that the hose (7) is connected both to an air pressure and to a vacuum line, whereby valves enable the alternating release of both lines.

7. Cutting and feed roller (1) according to claim 1, characterized in that the blade passage slit (3) can be closed with at least one baffle.

8. Cutting and feed roller (1) according to claim 1, characterized in that the baffle, which closes the blade passage slit (3), is pivot-articulated from at least one piston rod, whereby a cylinder is assigned to the piston rod, which on its part is articulated inside of the cutting and feed roller, and which is able to activate the baffle assigned to it by means of the cylinder moving the piston rod.

9. Cutting and feed roller (1) according to claim 1, characterized in that the blade passage slit can be closed with one or more sliders (15).

10. Cutting and feed roller 91) according to claim 1, characterized in that the slider (15) is activated by means of a piston rod unit (27, 28) that is articulated inside of the web guide roller (1).

11. Cutting and feed roller (1) according to claim 1, characterized by suction devices or vacuum chambers inside of the lateral surface (8) of the cutting and feed roller (1), which comprise connections with the openings in the lateral surface (8) of the cutting and feed roller.
